(19) United States
(12) Patent Application Publication
(10) Pub. No.: US 2025/0252076 A1
(43) Pub. Date: Aug. 7, 2025

(54) SYSTOLIC ARRAY, PROCESSING CIRCUIT INCLUDING SYSTOLIC ARRAY, AND ELECTRONIC DEVICE

(71) Applicant: SAMSUNG ELECTRONICS CO., LTD., Suwon-si (KR)

(72) Inventors: Joonho Kong, Daegu-si (KR); Juwon Seo, Daegu-si (KR)

(73) Assignee: Kyungpook National University Industry-Academic Cooperation Foundation, Daegu (KR)

(21) Appl. No.: 19/014,441

(22) Filed: Jan. 9, 2025

(30) Foreign Application Priority Data
Feb. 6, 2024 (KR) 10-2024-0018395
Apr. 18, 2024 (KR) 10-2024-0052396

(51) Int. Cl. G06F 15/80

(52) U.S. Cl. CPC G06F 15/8046

(57) ABSTRACT

Provided is a systolic array including a plurality of sub processing element (PE) arrays, wherein each of the plurality of sub PE arrays is configured to receive an input signal and to generate an output signal based on the received input signal, and a plurality of output direct path (ODP) circuits is configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

### CROSS-REFERENCE TO RELATED APPLICATION

This application is based on and claims priority under 35 U.S.C. § 119 to Korean Patent Application Nos. 10-2024-0018395, filed on Feb. 6, 2024, and 10-2024-0052396, filed on Apr. 18, 2024, in the Korean Intellectual Property Office, the contents of which are incorporated by reference herein in their entirety.

### TECHNICAL FIELD

The present disclosure relates to processing an artificial neural network (ANN), and more particularly to a systolic array (e.g., a versatile systolic array), a processing circuit including the same, and an electronic device including the processing circuit comprising the systolic array (e.g., the versatile systolic array).

### BACKGROUND

ANN models may be used in processing of rich and complex data in various domains including computer vision, speech recognition, natural language processing, video analysis, medical imaging and diagnostics, stock market predication, autonomous driving, robot navigation, etc. Processing ANNs may involve a large number of computations which may need additional considerations of computational efficiency.

Different aspects of computational efficiency may be more relevant for different applications. For example, power optimization may be a concern when implementing ANNs on a device due to limited battery. Moreover, computation speed may be more important for autonomous driving purposes, as short latency may be essential to guarantee a quick response to events on the road. Therefore, there is a need in the art for systems and methods to process ANNs more efficiently with respect to both computational speed and latency.

### SUMMARY

The present disclosure describes systems and methods for implementing a neural network (NN). Embodiments of the present disclosure include performing a matrix multiplication operation for processes such as training of the NN (e.g., a deep neural network, a convolutional neural network, etc.). In some cases, a systolic array that may be used for performing the matrix multiplication comprises an array of processing elements (PEs) that each perform a multiply and accumulation (MAC) operation. The systolic array may operate in different modes based on the density or sparsity of the input matrix which results in a highly efficient matrix multiplication operation and an enhancement of the processing speed.

The present disclosure provides a versatile systolic array that operates in two modes based on sparsity (i.e., corresponding to the frequency of 0 values) in an input matrix to perform matrix multiplication quickly and efficiently.

According to an aspect of the present disclosure, there is provided a systolic array including a plurality of sub processing element (PE) arrays, wherein each of the plurality of sub PE arrays is configured to receive an input signal and to generate an output signal based on the received input signal, and a plurality of output direct path (ODP) circuits configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

According to another aspect of the inventive concept, there is provided a processing circuit including a systolic array, wherein the systolic array includes a plurality of sub processing element (PE) arrays, wherein each of the plurality of sub PE arrays is configured to receive an input signal and to generate an output signal based on the received input signal, and a plurality of output direct path (ODP) circuits configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

According to another aspect of the inventive concept, there is provided an electronic device including a processing circuit including a systolic array, wherein the systolic array includes a plurality of sub processing element (PE) arrays, wherein each of the plurality of sub PE arrays is configured to receive an input signal and to generate an output signal based on the received input signal, and a plurality of output direct path (ODP) circuits is configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

According to another aspect of the inventive concept, there is provided an operating method for a systolic array comprising receiving input data, weight data, and a control signal by the systolic array, wherein the control signal indicates a first mode or a second mode and the weight data comprises uncondensed weight data in the first mode and condensed weight data in the second mode; generating output data based on the input data, weight data, and the control signal by the systolic array; and outputting the output data based on the control signal, wherein the output data is provided to an output buffer in the first mode and to a restoration circuit in the second mode

### BRIEF DESCRIPTION OF THE DRAWINGS

Embodiments of the inventive concept will be more clearly understood from the following detailed description taken in conjunction with the accompanying drawings:

FIG. 1 is a block diagram illustrating a processing circuit including a systolic array according to an embodiment;

FIG. 2 is a block diagram illustrating a processing circuit according to an embodiment;

FIG. 3 is a block diagram illustrating a processing systolic array according to an embodiment;

FIG. 4 is a diagram illustrating the operation of a plurality of sub PE arrays according to an embodiment;

FIG. 5 is a diagram illustrating the operation of one sub PE array, according to an embodiment;

FIG. 6 is a diagram illustrating the operation of one PE, according to an embodiment;

FIG. 7 is a diagram illustrating the operation of one ODP circuit, according to an embodiment;

FIG. 8 is a diagram illustrating the operation of one ODP circuit, according to an embodiment;

FIGS. 9 and 10 are diagrams illustrating an example method of operating the systolic array shown in FIG. 3;

FIG. 11 is a diagram illustrating the operation of a condensing circuit, according to an embodiment;

FIGS. 12 and 13 are diagrams illustrating an example operation of a processing circuit, according to an embodiment;

FIG. 14 shows a system to which a processing circuit is applied according to an embodiment; and

FIG. 15 shows a flowchart describing a process for operating a systolic array according to an embodiment.

### DETAILED DESCRIPTION OF THE EMBODIMENTS

A machine learning model comprises a systolic array architecture designed for high-performance computing tasks. In some cases, the systolic array may refer to a network of processors that rhythmically compute and pass data through the system, effectively parallelizing tasks and improving computational efficiency. With the increasing demand for real-time processing and the exponential growth in data generated by modern electronic devices, there is a need for specialized hardware that can handle these workloads efficiently.

Existing processing architectures may struggle to keep pace with the computational demands of contemporary applications, such as deep learning algorithms and large-scale data analytics. Such systems may deal with inefficiencies related to data movement and parallel processing, resulting in bottlenecks that limit performance and increase power consumption. Moreover, existing systems may lack the flexibility and scalability needed to adapt to the diverse and evolving demands of different computational tasks which leads to inefficiencies and a lack of general applicability across various domains.

The present disclosure describes systems and methods for implementing a neural network (NN). Matrix multiplication may be used in the field of artificial intelligence for operations such as in convolutional neural network (CNN) or deep neural network (DNN) training. A systolic array, which is a structure for performing matrix multiplication, may include an array of processing elements (PEs) that perform multiply and accumulation (MAC) operations. Embodiments of the present disclosure include performing a matrix multiplication operation for processes such as training of the NN (e.g., DNN, etc.). In some cases, a systolic array that may be used for performing the multiplication comprises an array of processing elements (PEs) that perform multiply and accumulation (MAC) operations. The systolic array may operate in different modes based on the density or sparsity of an input matrix which results in performing an efficient matrix multiplication and enhancement of the processing speed.

Embodiments of the present disclosure include a systolic array that includes a plurality of processing element (PE) sub-arrays and output direct path (ODP) circuits. A processing circuit comprising the systolic array receives the input matrix and generates an output matrix based on a weight matrix by implementing the MAC operations. In some cases, the processing circuit includes a control circuit configured to generate a first control signal or a second control signal that indicate a first mode or a second mode of operation, respectively. For example, the control circuit may output the first control signal or the second control signal based on a density level of the input matrix.

In some cases, the systolic array may process the input matrix (i.e., perform the MAC operation on the input matrix) based on a weight matrix in the first mode or based on a condensed weight matrix in the second mode to generate an output matrix. According to an embodiment, in case of the first mode, the systolic array may be configured to generate and transmit a first output data (e.g., the output matrix comprising first partial data) to an output buffer of the processing circuit for post-processing or reuse as the input matrix. According to an embodiment, in case of the second mode, the systolic array may be configured to generate and transmit a second output data (e.g., the output matrix comprising first partial data and different from the first output data) to a restoration circuit of the processing circuit.

According to an embodiment, the systolic array may operate in a first mode in response to a case where an input matrix is a dense matrix based on sparsity corresponding to the frequency of 0 values of the input matrix or may operate in a second mode in response to a case where the input matrix is a sparse matrix. In some cases, the systolic array may include a preloaded weight matrix corresponding to values included in a condensed weight matrix in the second mode.

In some cases, the condensing circuit may be used to condense an input weight matrix. For example, the condensing circuit may be configured to divide an input weight matrix into a plurality of sub-row matrices. In some cases, the condensing circuit may delete columns in each of the sub-row matrices that include only zeros to generate the condensed weight matrix for implementing MAC operations in the second mode. Additionally, the condensing circuit may generate metadata to store relevant column information and may provide the generated metadata to the restoration circuit for restoring the output matrix based on a rearrangement of the partial data based on the received metadata.

The present disclosure describes a systolic array comprising a plurality of sub processing elements (PE) arrays and a plurality of output direct path (ODP) circuits. In some cases, each of the plurality of sub PE arrays is configured to receive an input signal and to generate an output signal based on the received input signal. Additionally, the plurality of ODP circuits is configured to operate in a first mode and in a second mode. For instance, an ODP circuit may receive the output signal of a previous sub PE array of the plurality of sub PE arrays and provides the output signal to a next sub PE array in the first mode and may output the output signal in the second mode. In some examples, the output signal output in the second mode may be different from the output signal in the first mode.

An embodiment of the present disclosure describes a method for operating a systolic array. In some cases, the systolic array receives input data, weight data, and a control signal. In some cases, the control signal indicates a first mode or a second mode. In some cases, the weight data comprises uncondensed weight data in the first mode and condensed weight data in the second mode. The systolic array generates output data based on the input data, weight data, and the control signal. Additionally, the systolic array outputs the output data based on the control signal. In some cases, the output data is provided to an output buffer in the first mode and to a restoration circuit in the second mode.

Accordingly, by implementing the first and second modes for operating the systolic array, embodiments of the present disclosure may perform efficient matrix multiplication both when the input matrix is a dense matrix and when the input matrix is a sparse matrix. Additionally, by preloading weights corresponding to the values included in a condensed weight matrix to the systolic array in the second mode, embodiments are able to partially skip an operation on 0 values which results in an enhancement of the overall processing speed. In case of the second mode, each of the plurality of sub PE arrays may operate as one systolic array resulting in reduction of the number of clock cycles needed for an MAC operation and a further enhancement of the overall processing speed.

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, a systolic array, processing circuit including systolic array, and electronic device of the embodiments of the present disclosure will be described in detail with reference to the accompanying drawings. When describing the embodiments with reference to the accompanying drawings, like reference numerals refer to like elements and a repeated description related thereto will be omitted.

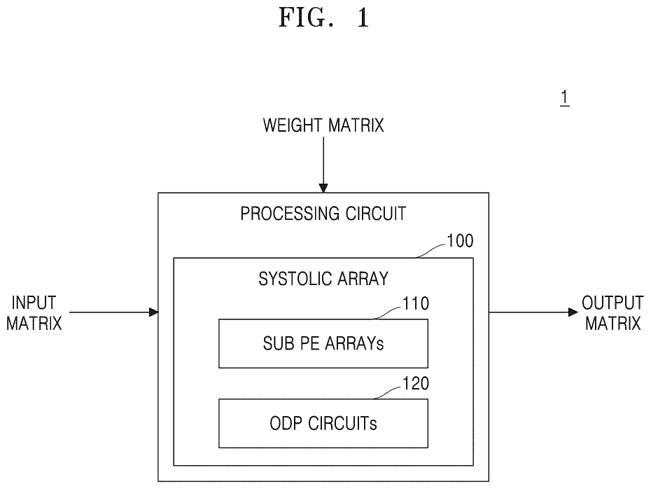

FIG. 1 is a block diagram illustrating a processing circuit including a systolic array, according to an embodiment. Hereinafter, a processing circuit including a systolic array 100 will be referred to as processing circuit 1. Additionally, according to an embodiment, the processing circuit 1 may be referred to as an accelerator.

Referring to FIG. 1, the processing circuit 1 may receive an input matrix and a weight matrix as input and perform a multiplication and accumulation (MAC) operation on the input matrix and the weight matrix, thereby generating an output matrix.

Machine learning models or an artificial neural network (ANN) may be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

In some cases, the ANN may be processed based on a multiplication and accumulation (MAC) operation which may be a mathematical process used to compute the output of neurons in a layer. Each neuron in a neural network receives input signals, which may be numerical values representing features or activations from the previous layer. The MAC operation may be responsible for combining the inputs with the corresponding weights associated with each connection. The MAC operation comprises two primary steps, i.e., multiplication and accumulation.

For each input to the neuron, the input value is multiplied by its corresponding weight. Mathematically, if a neuron receives inputs x₁, x₂, . . . , xₙ with corresponding weights w₁, w₂, . . . , wₙ, the multiplication step generates a series of products: x₁×w₁, x₂×w₂, . . . , xₙ×wₙ. After multiplying each input by the weight, the results are summed up. In some cases, the sum may represent the weighted sum of the inputs. Mathematically, the accumulation step generates a single value: y=Σᵢ₌₁ⁿxᵢ×wᵢ, where y is the output of the MAC operation.

According to an embodiment of the present disclosure, the processing circuit 1 may store values of the weight matrix in a systolic array. In some cases, the processing circuit 1 may reuse the values of the weight matrix even after a MAC operation. In some cases, the processing circuit 1 may receive the input matrix (e.g., only the input matrix) as input and perform a MAC operation on the values of the received input matrix based on the weight matrix stored in the systolic array. Accordingly, the processing circuit 1 may generate the output matrix as described herein. Additionally, storing the values of the weight matrix in the systolic array may refer to preloading the values of the weight matrix in the systolic array.

As described, the MAC operation may refer to an operation of multiplying two input values and accumulating a result thereof. A MAC operation is a type of operation used in machine learning, such as a neural network, and a signal processing algorithm, and, more particularly, may be widely used in a neural network structure such as a convolutional neural network (CNN).

Multiplication as used in the MAC operation may refer to multiplication operations between weight parameters and input values (e.g., input data) of a neural network. Additionally, accumulation as used in the MAC operation may refer to an operation of calculating a final output value based on accumulating results of the multiplication between the weight parameters and the input values.

The number of MAC operations may be used to measure the complexity and the computational cost of a neural network model. Additionally, the number of MAC operations of a model may enable evaluation of the computational complexity of the model and the complexity of a graph. In some cases, the number of MAC operations may be used as an indicator for optimizing or comparing models. Particularly, the number of MAC operations may enable evaluation of the performance of a model or hardware or may be used to improve the size and efficiency of a model.

According to the present disclosure, the processing circuit 1 may operate in a first mode when an input matrix is a dense matrix based on sparsity corresponding to the frequency of 0 values of the input matrix. In some cases, the processing circuit 1 may operate in a second mode when the input matrix is a sparse matrix.

Hereinafter, the first mode may refer to a mode in which a dense matrix (i.e., with a frequency of 0 values lower than a predefined frequency) is input as an input matrix. Hereinafter, the second mode may refer to a mode in which a sparse matrix (i.e., with a frequency of 0 values greater than or equal to the predefined frequency) is input as an input matrix.

Therefore, the processing circuit 1 of the present disclosure may perform efficient matrix multiplication when the input matrix is a dense matrix and when the input matrix is a sparse matrix.

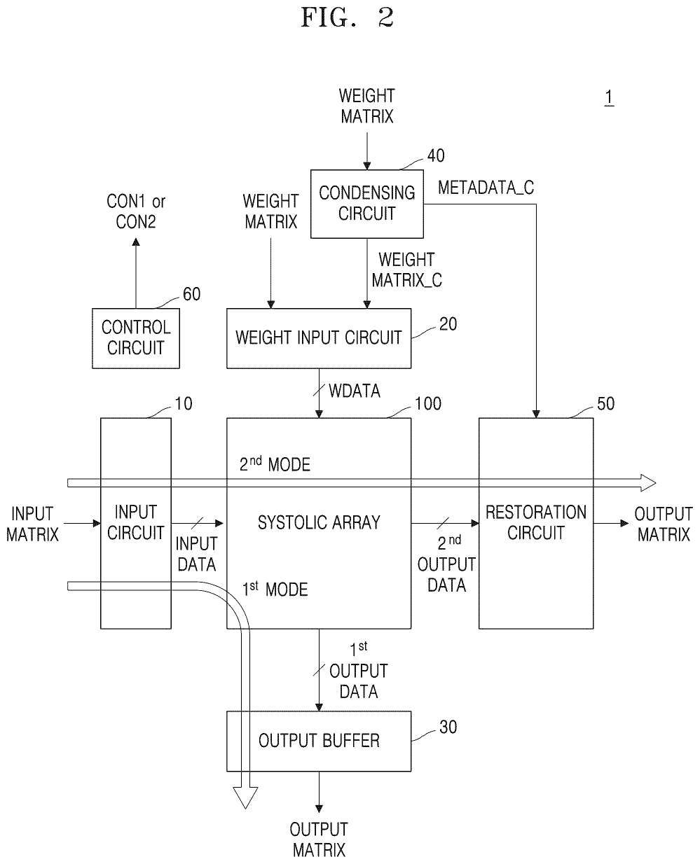

According to an embodiment, the systolic array 100 included in the processing circuit 1 includes a plurality of sub processing element (PE) arrays 110 and a plurality of output direct path (ODP) circuits 120. In some cases, each of the plurality of sub PE arrays 110 may include m×n PEs arranged in an m×n matrix. In some cases, each of the plurality of ODP circuits 120 may receive an output signal of a previous sub PE array and provide the output signal of the previous sub PE array to a next sub PE array. Additionally or alternatively, each of the plurality of ODP circuits 120 may output the output signal of the previous sub PE array. As used herein, m and n may refer to positive integers. In some cases, the plurality of ODP circuits 120 may each provide an output signal of the previous sub PE array to the next sub PE array in the first mode. In some cases, the plurality of ODP circuits 120 may each output the output signal of the previous sub PE array in the second mode. Further details regarding an operation of the systolic array 100 will be described with reference to FIGS. 2 to 13.

According to an embodiment of the present disclosure, each of the plurality of sub PE arrays 110 may individually operate as one systolic array in the second mode. Thus, the number of clock cycles needed for a MAC operation may be reduced and the overall processing speed may be improved.

FIG. 2 is a block diagram illustrating a processing circuit, according to an embodiment.

Referring to FIG. 2, the processing circuit 1 may include the systolic array 100, an input circuit 10, a weight input circuit 20, an output buffer 30, a condensing circuit 40, a restoration circuit 50 and a control circuit 60. In some cases, the output buffer 30 and the restoration circuit 50 may be implemented as one output circuit. In some cases, the condensing circuit 40 and the restoration circuit 50 may be implemented as one circuit. In some cases, the output buffer 30, the condensing circuit 40, and the restoration circuit 50 may be implemented as one circuit.

Referring to FIG. 2, the input circuit 10 may receive an input matrix as an input and output the input data as an output. In some cases, the input circuit 10 performs a pre-processing operation on the input matrix to generate the input data. In some cases, the input circuit 10 may be referred to as a scratch pad.

According to an embodiment, the input circuit 10 may store an input matrix applied from the outside. In some cases, the input circuit 10 may be implemented within a memory. For example, the input circuit 10 may be implemented within a volatile memory such as dynamic random access memory (DRAM), mobile DRAM, static random access memory (SRAM), phase-change random access memory (PRAM), ferroelectric random access memory (FRAM), resistive random access memory (RRAM), and/or magnetoresistive random access memory (MRAM).

In some cases, the input circuit 10 may generate input data by dividing the input matrix (e.g., column-wise dividing the input matrix) and sequentially providing the generated input data to the systolic array 100 in synchronization with a clock signal. For example, a piece of input data may correspond to a value included in each column of the input matrix. In some examples, at least one piece of input data may be provided to the systolic array 100 at the same time.

Additionally, input data corresponding to a first row of a first column of the input matrix and input data corresponding to a first row of a second column of the input matrix may be provided to the systolic array 100 at different time points. For example, the input data corresponding to the first row of the second column of the input matrix may be provided to the systolic array 100 after the input data corresponding to the first row of the first column of the input matrix is provided to the systolic array 100. In some examples, input data corresponding to a second row of the first column of the input matrix and the input data corresponding to the first row of the second column of the input matrix may be provided simultaneously to the systolic array 100.

The weight input circuit 20 may receive a matrix as an input value and output weight data WDATA as an output value. As described herein, the weight data WDATA may be generated when the weight input circuit 20 performs a pre-processing operation on a matrix (e.g., a weight matrix WEIGHT MATRIX or a condensed weight matrix WEIGHT MATRIX_C).

In some cases, the weight input circuit 20 may receive a weight matrix as input and output the weight data WDATA as output in the first mode. Additionally, the weight input circuit 20 may receive the condensed weight matrix WEIGHT MATRIX_C as input and output the weight data WDATA as output in the second mode.

According to an embodiment, the weight input circuit 20 may store the weight matrix or the condensed weight matrix WEIGHT MATRIX_C (e.g., the condensed weight matrix may be provided externally). In some cases, the weight input circuit 20 may be implemented within a memory. For example, the weight input circuit 20 may be implemented within a volatile memory such as DRAM, mobile DRAM, SRAM, PRAM, FRAM, RRAM, and/or MRAM.

The weight input circuit 20 may generate the weight data WDATA corresponding to each weight value included in a received matrix and may provide the weight data WDATA to the systolic array 100. As described herein, the plurality of PEs included in the systolic array 100 may each store a corresponding weight value and may re-use the weight data WDATA when performing a MAC operation on the input matrix.

In some cases, the weight input circuit 20 may provide the weight data WDATA corresponding to values included in the weight matrix to the systolic array 100 in the first mode. In some cases, the plurality of PEs included in the systolic array 100 may store a corresponding value from among values included in the weight matrix. The plurality of PEs may each re-use the corresponding value from among values included in the weight matrix when performing a MAC operation on the input matrix.

In some cases, the weight input circuit 20 may provide the weight data WDATA corresponding to values included in the condensed weight matrix WEIGHT MATRIX_C to the systolic array 100 in the second mode. In some cases, the plurality of PEs included in the systolic array 100 may each store a corresponding value from among the values included in the condensed weight matrix WEIGHT MATRIX_C. The plurality of PEs may each re-use a corresponding value from among the values included in the condensed weight matrix WEIGHT MATRIX_C during a MAC operation on the input matrix.

Accordingly, by preloading weights corresponding to the values included in the condensed weight matrix WEIGHT MATRIX_C to the systolic array 100 in the second mode, embodiments of the present disclosure may be able to partially skip an operation on 0 values which results in an improvement in the overall processing speed of the system.

The output buffer 30 may receive first output data as an input and generate an output matrix as an output in the first mode. In some cases, the output matrix may be obtained when the output buffer 30 rearranges the first output data.

Additionally, the output buffer 30 may store the first output data or the output matrix. According to an embodiment, the output buffer 30 may be implemented with a memory. For example, the output buffer 30 may be implemented with a volatile memory such as DRAM, mobile DRAM, SRAM, PRAM, FRAM, RRAM, and/or MRAM.

According to an embodiment, the output buffer 30 may perform a function operation corresponding to post-processing, such as activation, normalization, and/or max pooling, according to an artificial intelligence (AI) algorithm. Additionally, the output buffer 30 may store a result of performing post-processing on the first output data (i.e., an output matrix) in the output buffer 30. In some cases, the output buffer 30 may apply the result to the processing circuit 1 as an input for the processing circuit 1 (i.e., the output buffer 30 may enable reuse of the output matrix as input for the processing circuit 1). Thus, the input circuit 10 and the output buffer 30 may be connected bidirectionally.

The condensing circuit 40 may receive a matrix (e.g., a weight matrix) as an input and generate a condensed matrix as an output. In some cases, the condensed matrix may be obtained as the condensing circuit 40 performs a matrix condensing operation on the weight matrix. As described herein, the matrix condensing operation may refer to an operation of reducing the dimensions of a matrix.

Referring to FIG. 2, the condensing circuit 40 may receive the weight matrix as an input and generate the condensed weight matrix WEIGHT MATRIX_C as an output. In some cases, the condensed weight matrix WEIGHT MATRIX_C may be obtained as the condensing circuit 40 performs a matrix condensing operation on the received weight matrix.

Additionally, the condensing circuit 40 may generate condensing metadata METADATA_C by generating a condensed matrix and provide the condensing metadata METADATA_C to the restoration circuit 50.

According to an embodiment, the condensing circuit 40 may generate the condensing metadata METADATA_C by generating the condensed weight matrix WEIGHT MATRIX_C and provide the condensing metadata METADATA_C to the restoration circuit 50.

In some cases, the condensing metadata METADATA_C may represent metadata corresponding to a condensed matrix generated using a matrix condensing operation. For example, the condensing metadata METADATA_C may include information regarding the characteristics of the weight matrix, the dimension and the structure of the weight matrix, and the algorithm or parameters used during the condensing operation.

The restoration circuit 50 may receive second output data as an input and generate an output matrix as an output in the second mode. In some cases, the restoration circuit 50 may generate partial sum matrices based on the second output data. Additionally, the restoration circuit 50 may generate restored partial sum matrices respectively corresponding to generated partial sum matrices by rearranging generated partial sum matrices based on the condensing metadata METADATA_C. In some cases, the restoration circuit 50 may generate the output matrix based on a sum of restored partial sum matrices.

The condensing circuit 40 and/or the restoration circuit 50 may be implemented with software, hardware, or a combination of hardware and software.

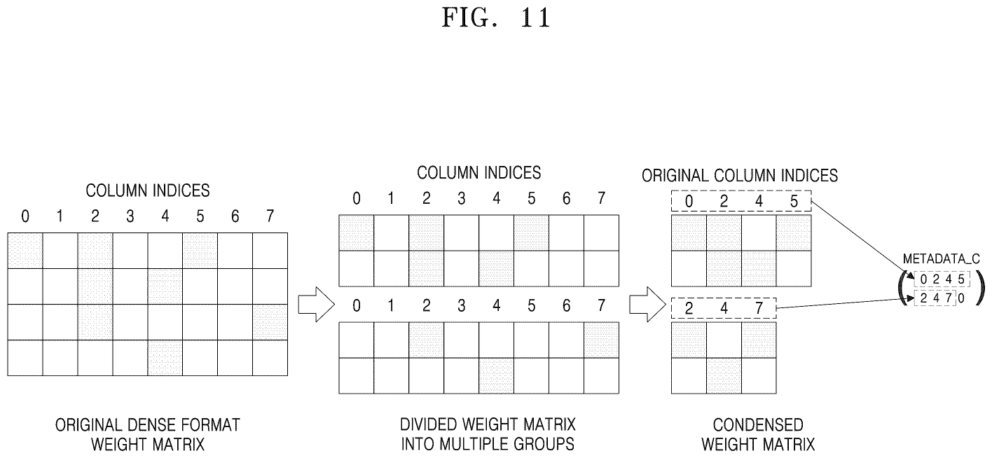

Further details regarding operations of the condensing circuit 40 and the restoration circuit 50 will be described with reference to FIGS. 11 to 13.

The control circuit 60 may control various operations of the processing circuit 1. For example, the processing circuit 1 may operate in the first mode in response to a first control signal CON1 of the control circuit 60 and may operate in the second mode in response to a second control signal CON2 of the control circuit 60.

According to an embodiment, the control circuit 60 may output the first control signal CON1 in response to an external command instructing to operate in the first mode. In some cases, the control circuit 60 may output the second control signal CON2 in response to an external command instructing to operate in the second mode. The processing circuit 1 may operate in the first mode in response to the first control signal CON1 or in the second mode in response to the second control signal CON2.

According to some embodiments, the control circuit 60 may generate the first control signal CON1 or the second control signal CON2 based on sparsity corresponding to the frequency of 0 values included in the input matrix. For example, when the frequency of 0 values included in the input matrix is less than a pre-set number, the control circuit 60 may output the first control signal CON1. Accordingly, the processing circuit 1 may operate in the first mode in response to the first control signal CON1. For example, when the frequency of 0 values included in the input matrix is greater than or equal to the pre-set number, the control circuit 60 may output the second control signal CON2. Accordingly, the processing circuit 1 may operate in the second mode in response to the second control signal CON2.

The systolic array 100 may include an array of PEs that perform MAC operations. In some cases, the PEs may constitute a connection network and may perform MAC operations in synchronization with a global clock signal.

Additionally, the systolic array 100 may include three data flows, i.e., an input stationary data flow, a weight stationary data flow, and an output stationary data flow, depending on values stored in the systolic array 100.

In case of the weight stationary data flow, as a MAC operation is performed, a weight is preloaded in each of the PEs in the systolic array 100 and is not moved from each of the PEs.

According to an exemplary embodiment, the data flow of the systolic array 100 is assumed to be the weight stationary data flow of storing a weight in the systolic array 100.

However, embodiments are not limited to the systolic array 100 with a stationary weight and may be applied to a systolic array with an input stationary data flow and a systolic array with an output stationary data flow.

According to an embodiment, the systolic array 100 may receive input data as an input and generate first output data as an output in the first mode. Additionally, the systolic array 100 may receive input data as an input and generate second output data as an output in the second mode. In some cases, the first output data may be a result of a MAC operation based on the weight matrix. Unlike the first output data, the second output data may be a result of a MAC operation based on the condensed weight matrix WEIGHT MATRIX_C.

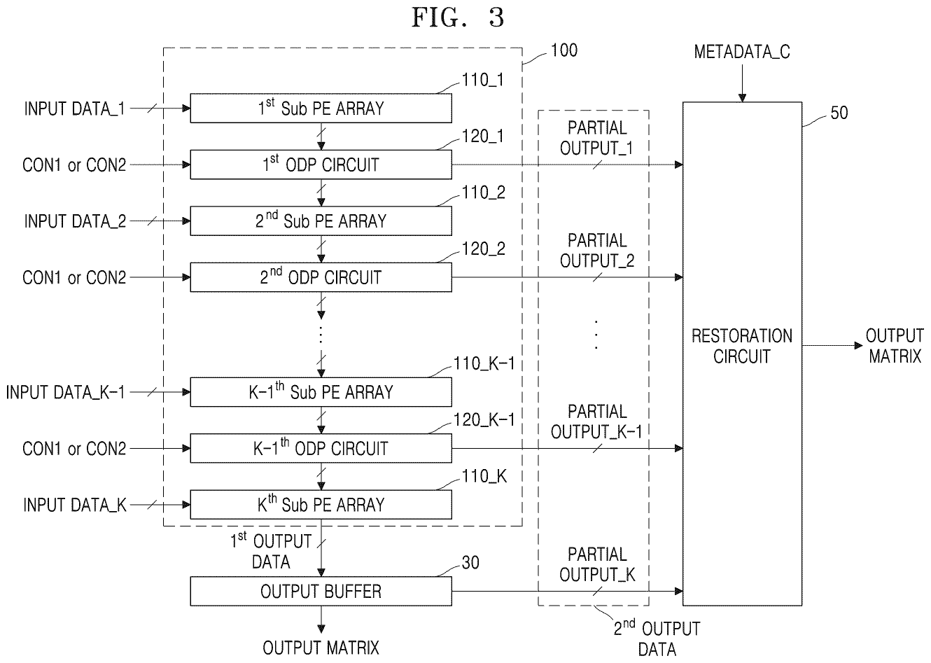

Further details regarding operation of the systolic array 100 will be described with reference to FIGS. 3 to 13.

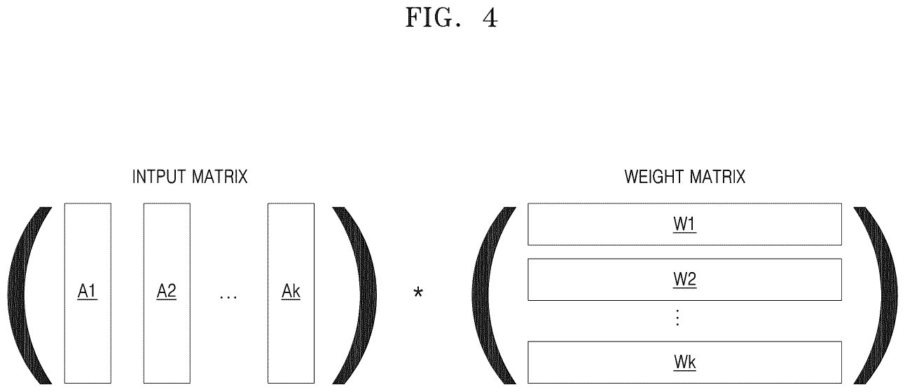

FIG. 3 illustrates a systolic array according to an embodiment. FIG. 4 illustrates an operation of a plurality of sub PE arrays according to an embodiment.

The systolic array 100 may include the plurality of sub PE arrays 110 and the plurality of ODP circuits 120.

As used herein, the plurality of sub PE arrays 110 may each include m x n PEs arranged in an m x n matrix. Here, m and n may be positive integers.

Additionally, each ODP circuit of the plurality of ODP circuits 120 may receive an output signal of a previous sub PE array and provide the output signal of the previous sub PE array to the next sub PE array in the first mode. Additionally or alternatively, each ODP circuit of the plurality of ODP circuits 120 may receive an output signal of a previous sub PE array and output the output signal of the previous PE array in the second mode. For example, each ODP circuit of the plurality of ODP circuits 120 may provide an output signal of a previous sub PE array to the restoration circuit 50 or provide the output signal to the outside in the second mode.

Referring to FIG. 3, the systolic array 100 may include first to K-th sub PE arrays 110_1 to 110_K and first to (K-1)-th ODP circuits 120_1 to 120_K-1. As shown in FIG. 3, the number of ODP circuits may be one less than the number of sub PE arrays. In some cases, K may be a positive integer.

Further details regarding the operation of the plurality of sub PE arrays 110 will be provided with reference to FIGS. 4 to 6.

FIG. 4 illustrates multiplication of an input matrix and a weight matrix, according to an embodiment.

Referring to FIGS. 3 and 4, the input matrix may be divided into at least one column. For example, the input matrix may be divided into K sub column matrices, that is, first to K-th sub column matrices A1 to Ak as shown in FIG. 4.

Additionally, each sub column matrix may correspond to one of the pieces of input data. For example, each of the first to K-th sub column matrices A1 to AK of FIG. 4 may correspond to one of first to K-th input data INPUT DATA_1 to INPUT DATA_K of FIG. 3. For example, a first sub column matrix A1 may correspond to first input data INPUT DATA_1 and a second sub column matrix A2 may correspond to second input data INPUT DATA_2.

Additionally, the weight matrix may be divided into at least one row. For example, the weight matrix may be divided into K sub row matrices, that is, first to K-th sub row matrices W1 to Wk of FIG. 4.

In some cases, each sub row matrix may correspond to weight data stored in a plurality of sub PE arrays. For example, each of the first to K-th sub row matrices W1 to WK of FIG. 4 may be stored in one of the first to K-th sub PE arrays 110_1 to 110_K of FIG. 3. For example, a first sub row matrix W1 may be stored in a first sub PE array 110_1, and a second sub row matrix W2 may be stored in a second sub PE array 110_2. In some cases, storing sub row matrices of a weight matrix in sub PE arrays may be referred to as preloading weights to the sub PE array.

Referring again to FIG. 3, each sub PE array of the plurality of sub PE arrays 110 may receive corresponding input data and a result of a MAC operation of a previous sub PE array as input, and each sub PE array of the plurality of sub PE arrays 110 may provide the result of the MAC operation to a corresponding ODP circuit.

For example, the first to K-th sub PE arrays 110_1 to 110_K may receive the first to K-th input data INPUT DATA_1 to INPUT DATA_K and a result of a MAC operation of a previous sub PE array (i.e., since the first sub PE array 110_1 is a starting point of a MAC operation, the first sub PE array 110_1 does not receive a result of a previous MAC operation) as input, each of the first sub PE array 110_1 to (K-1)-th sub PE array 110_K-1 may provide a result of a MAC operation to a corresponding ODP circuit. In some cases, a K-th sub PE array 110_K may provide a result of a MAC operation to the output buffer 30.

In some cases, a result of the MAC operation may mean the partial sum which refers to an accumulation of results of multiplying weight values and input values.

Additionally, a result of a MAC operation received by the output buffer 30 in the first mode may be the first output data (i.e., first output data may be the final output of the systolic array 100).

In some cases, the output matrix may be generated based on rearranging the first output data. For example, the output matrix may be obtained by multiplying the input matrix and the weight matrix.

Each ODP circuit of the plurality of ODP circuits 120 may be disposed between two sequential sub PE arrays and may provide an output signal of the previous sub PE array to the next sub PE array. In some cases, each ODP circuit may provide the output signal of the previous sub PE array to the outside of the systolic array 100, according to an operation mode, i.e., the first mode or the second mode. As described with reference to FIG. 2, the plurality of ODP circuits 120 may each operate in the first mode in response to the first control signal CON1 or in the second mode in response to the second control signal CON2.

For example, a first ODP circuit 120_1 may be disposed between the first sub PE array 110_1 and the second sub PE array 110_2.

In case of the first mode, each ODP circuit of the plurality of ODP circuits 120 may receive an output signal of a previous sub PE array as an input and provide the output signal of the previous sub PE array to a next sub PE array. For example, in case of the first mode, the first ODP circuit 120_1 may receive an output signal of the first sub PE array 110_1 as an input and provide the output signal of the first sub PE array 110_1 to the second sub PE array 110_2.

In case of the second mode, each ODP circuit of the plurality of ODP circuits 120 may provide an output signal of a previous sub PE array to the restoration circuit 50. For example, in case of the second mode, the first ODP circuit 120_1 may receive an output signal of the first sub PE array 110_1 as an input and provide the output signal of the first sub PE array 110_1 to the restoration circuit 50.

In case of the second mode, one sub PE array and one ODP circuit corresponding to the sub PE array may be referred to as one sub systolic array. Additionally, a plurality of sub systolic arrays may each independently operate as one systolic array.

For example, in case of the first mode, a starting time point (e.g., a time period) of applying the first input data INPUT DATA_1 to the first sub PE array 110_1 and the starting time point (e.g., a time period) of applying the second input data INPUT DATA_2 to the second sub PE array 110_2 may not overlap each other.

In some cases, in case of the second mode, the first sub PE array 110_1 and the first ODP circuit 120_1 may constitute one sub systolic array. Additionally, the second sub PE array 110_2 and a second ODP circuit 120_2 may constitute one sub systolic array. Therefore, in case of the second mode, a starting time point (e.g., a time period) of applying the first input data INPUT DATA_1 to the first sub PE array 110_1 and the starting time point (e.g., a time period) of applying the second input data INPUT DATA_2 to the second sub PE array 110_2 may overlap each other.

In some cases, a plurality of sub systolic arrays may each individually operate as one systolic array. Therefore, the number of clock cycles needed for a MAC operation may be reduced and the processing speed of the processing circuit 1 may be improved.

In case of the second mode, each ODP circuit of the plurality of ODP circuits 120 may provide a result of a MAC operation of a previous sub PE array to the restoration circuit 50. In some cases, a result of the MAC operation may mean the partial sum which refers to an accumulation of results of multiplying weight values and input values.

For example, in case of the second mode, the first ODP circuit 120_1 may provide first partial sums PARTIAL OUTPUT_1 (i.e., first partial sums may refer to results of a MAC operation of the first sub PE array 110_1) to the restoration circuit 50. Additionally, in case of the second mode, the second ODP circuit 120_2 may provide second partial sums PARTIAL OUTPUT_2 (i.e., second partial sums may refer to results of a MAC operation of the second sub PE array 110_2) to the restoration circuit 50.

Thus, in the second mode, the first ODP circuit 120_1 to (K-1)-th ODP circuit 120_K-1 may each provide partial sums, which are results from a MAC operation of a corresponding sub PE array, to the restoration circuit 50.

Additionally, in the second mode, the output buffer 30 may operate as an ODP circuit. For example, in the second mode, the output buffer 30 may provide K-th partial sums PARTIAL OUTPUT_K (i.e., K-th partial sums may refer to results of a MAC operation of a K-th sub PE array 110_K) to the restoration circuit 50.

Hereinafter, first partial sum PARTIAL OUTPUT_1 to K-th partial sum PARTIAL_K may be referred to as second output data in the second mode.

The restoration circuit 50 may receive the second output data including the first partial sum PARTIAL OUTPUT_1 to K-th partial sum PARTIAL_K as an input in the second mode. The restoration circuit 50 may generate partial sum matrices based on the second output data. Additionally, the restoration circuit 50 may generate restored partial sum matrices respectively corresponding to generated partial sum matrices by rearranging generated partial sum matrices based on the condensing metadata METADATA_C. Additionally, the restoration circuit 50 may provide the output matrix by summing each of the restored partial sum matrices.

In some cases, the output matrix may be generated corresponding to the multiplication of the input matrix and the weight matrix may be completed by generating partial sum matrices based on partial sums (e.g., the first partial sum PARTIAL OUTPUT_1 to K-th partial sum PARTIAL_K), generating restored partial sum matrices by rearranging the partial sum matrices, and performing a summation of each of the restored partial sum matrices.

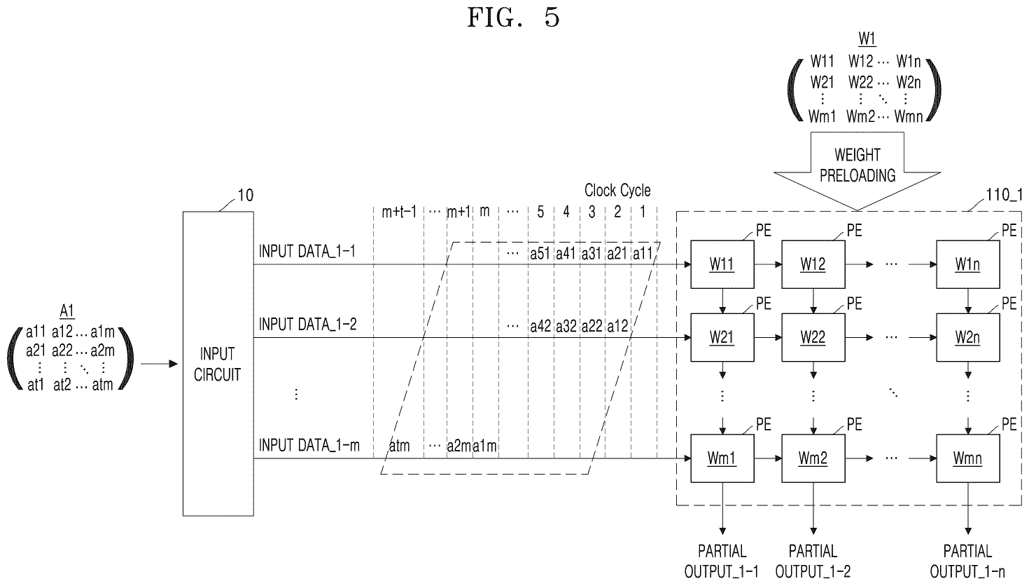

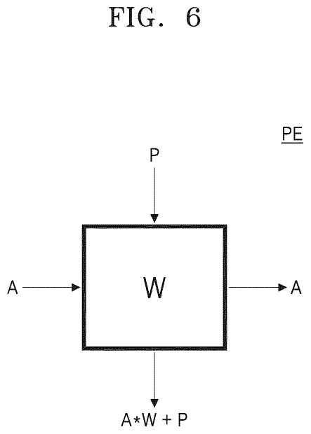

FIG. 5 illustrates the operation of one sub PE array, according to an embodiment. FIG. 6 illustrates the operation of one PE, according to an embodiment. FIG. 5 illustrates an example of the first sub PE array 110_1 shown in FIG. 3. The plurality of sub PE arrays 110 described with reference to FIG. 3 may include the same configuration and perform the same operation. Therefore, the configuration and the operation of the first sub PE array 110_1 shown in FIG. 3 are described herein.

Referring to FIG. 5, the first sub PE array 110_1 may include m x n PEs arranged in an m x n matrix. Here, m and n may be positive integers.

FIG. 6 describes an operation of a PE.

FIG. 6 illustrates an operation of a PE from among the plurality of PEs shown in FIG. 5.

The PE may receive an input value A and a partial sum P as input. In some cases, the PE may provide a result of a MAC operation (A*W+P) to a next PE in a first direction via the path of the partial sum P->A*W+P. The PE may perform multiplication on the input value A and a preloaded weight W and may accumulate results of multiplications in the partial sum P, thereby generating a result of a MAC operation (A*W+P).

Additionally, the PE may provide the input value A to a next processing element PE in a second direction through the path of the input value A.

In some cases, the PE may have two data paths including the path of the input value A and the path of the partial sum P, wherein the first direction may correspond to the path of the partial sum P and the second direction may correspond to the path of the input value A. Referring to FIGS. 3, 5, and 6, a sub PE array may be connected to an ODP circuit on the path of the partial sum P in the first direction.

Referring to FIGS. 4 and 5, the processing circuit 1 may preload the weight data WDATA corresponding to the first sub row matrix W1 to m×n PEs of the first sub PE array 110_1 arranged in an m×n matrix form. In some cases, the dimension of the first sub row matrix W1 may be m×n. In some cases, an element of the first sub row matrix W1 may be stored in a PE.

For example, a PE W11 may store a weight W11, a PE W12 may store a weight W12, and a PE W21 may store a weight W21, etc.

Referring to FIGS. 4 and 5, the first sub PE array 110_1 may receive the first input data INPUT DATA_1 corresponding to the first sub column matrix A1 as an input. In some cases, the input circuit 10 may perform a pre-processing operation on the first sub column matrix A1 of the input matrix, thereby generating 1st-1 input data INPUT DATA_1-1 to 1st-m input data INPUT DATA_1-m. In some cases, the dimension of the first sub row matrix W1 may be t×m, where t may be a positive integer.

The input circuit 10 may synchronize the first input data INPUT DATA_1 with a clock signal via a plurality of channels. In some cases, the input circuit 10 may provide synchronized first input data INPUT DATA_1 to the first sub PE array 110_1. In some examples, the number of channels may correspond to the number of columns of the first sub column matrix A1 and/or the number of rows of the first sub row matrix W1.

For example, the input circuit 10 may synchronize the 1st-1 input data INPUT DATA_1-1 to 1st-m input data INPUT DATA_1-m with a clock signal and provide synchronized data to the first sub PE array 110_1 for m+t−1 clock cycles through m channels.

Additionally, the input circuit 10 may synchronize elements of a column of the sub column matrix (for example, A1) with a clock signal through a channel and sequentially provide synchronized elements to PEs of a corresponding row of the first sub PE array 110_1. Additionally, elements of a column (i.e., the corresponding column) of the corresponding sub column matrix (for example, A1) may be sequentially moved in synchronization with a clock signal between the PEs of the corresponding row.

Referring to FIG. 5, e.g., the input circuit 10 may synchronize elements of the first column of the first sub column matrix A1 with a clock signal through the channel of 1st-1 input data INPUT DATA_1-1 and sequentially provide synchronized elements to first to n-th PEs W11 to W1n of the first row of the first sub PE array 110_1. Additionally, elements of the first column of the first sub column matrix A1 may be sequentially moved in synchronization with a clock signal between the first to n-th PEs W11 to Win of the first row of the first sub PE array 110_1.

Similarly, as shown in FIG. 5, the input circuit 10 may synchronize elements of the m-th column of the first sub column matrix A1 with a clock signal through the channel of 1st-m input data INPUT DATA_1-m and may sequentially provide synchronized elements to first PE Wm1 to n-th PE Wmn of the m-th row of the first sub PE array 110_1. Thus, elements of the m-th column of the sub column matrix (for example, A1) may be sequentially moved in synchronization with a clock signal between the first PE Wm1 to n-th PE Wmn of the m-th row of the first sub PE array 110_1.

Referring again to FIG. 5, start time in the application of the 1st-1 input data INPUT DATA_1-1 to 1st-m input data INPUT DATA_1-m may be different from each other. For example, 1 st-2 input data INPUT DATA_1-2 may be provided to the first sub PE array 110_1 after the 1st-1 input data INPUT DATA_1-1 is provided to the first sub PE array 110_1 and one clock cycle has elapsed.

The first sub PE array 110_1 may output the first partial sums PARTIAL OUTPUT_1 in synchronization with a clock signal through a plurality of channels. In some cases, the number of channels may correspond to the number of columns of the first sub row matrix W1.

Referring to FIG. 3, the first sub PE array 110_1 may provide the first partial sums PARTIAL OUTPUT_1 to the first ODP circuit 120_1 in synchronization with a clock signal through a plurality of channels.

Referring to FIG. 5, the first PE Wml to n-th PE Wmn of the m-th row of the first sub PE array 110_1 may output 1st-1 partial sum PARTIAL OUTPUT_1-1 to 1st-n partial sums PARTIAL OUTPUT_1-n through the channel of the partial sum P. In some cases, the final output of a first PE Wm1 of the m-th row may be output first. Subsequently, the final output of a second PE Wm2 of the m-th row may be output after one clock cycle has elapsed. Similarly, the final output of a third PE Wm3 of the m-th row may be output after another clock cycle has elapsed.

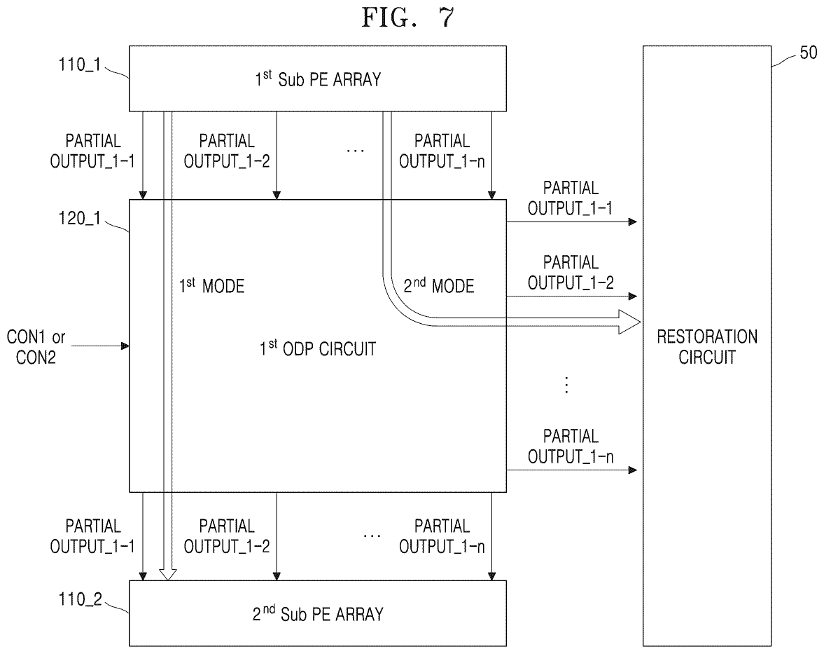

FIG. 7 illustrates the operation of one ODP circuit, according to an embodiment. FIG. 7 is a block diagram showing an operation of the first ODP circuit 120_1 shown in FIG. 3. The plurality of ODP circuits 120 described with reference to FIG. 3 may include the same configuration and perform the same operation. Further details regarding an operation of the first ODP circuit 120_1 shown in FIG. 3 are provided herein.

Each ODP circuit of the plurality of ODP circuits 120 may receive an output signal of a previous sub PE array. In some cases, the ODP circuit may provide the output signal of the previous sub PE array to the next sub PE array in the first mode and may provide the output signal of the previous PE array in the second mode. For example, each ODP circuit of the plurality of ODP circuits 120 may provide an output signal of a previous sub PE array to the restoration circuit 50 or provide the output signal to the outside in the second mode.

In some cases, each ODP circuit of the plurality of ODP circuits 120 may operate in the first mode in response to the first control signal CON1 or in the second mode in response to the second control signal CON2.

Referring to FIG. 7, the first ODP circuit 120_1 may operate in the first mode in response to the first control signal CON1. In the first mode, the first ODP circuit 120_1 may receive an output signal of the first sub PE array 110_1 and provide the output signal of the first sub PE array 110_1 to the second sub PE array 110_2.

Additionally, the first ODP circuit 120_1 may operate in the second mode in response to the second control signal CON2. In the second mode, the first ODP circuit 120_1 may receive an output signal of the first sub PE array 110_1 and provide the output signal of the first sub PE array 110_1 to the restoration circuit 50.

In some cases, the output signal of the previous sub PE array may be partial sums. Referring to FIG. 7, the output signal of the first sub PE array 110_1 may be the 1st-1 partial sum PARTIAL OUTPUT_1-1 to 1st-n partial sum PARTIAL OUTPUT_1-n. Thus, the output signal of the first sub PE array 110_1 may be the first partial sum PARTIAL OUTPUT_1. Additionally, the output signal of the second sub PE array 110_2 may be 2nd-1 partial sum PARTIAL OUTPUT_2-1 to 2nd-n partial sum PARTIAL OUTPUT_2-n. Thus, the output signal of the second sub PE array 110_2 may be the second partial sum PARTIAL OUTPUT_2.

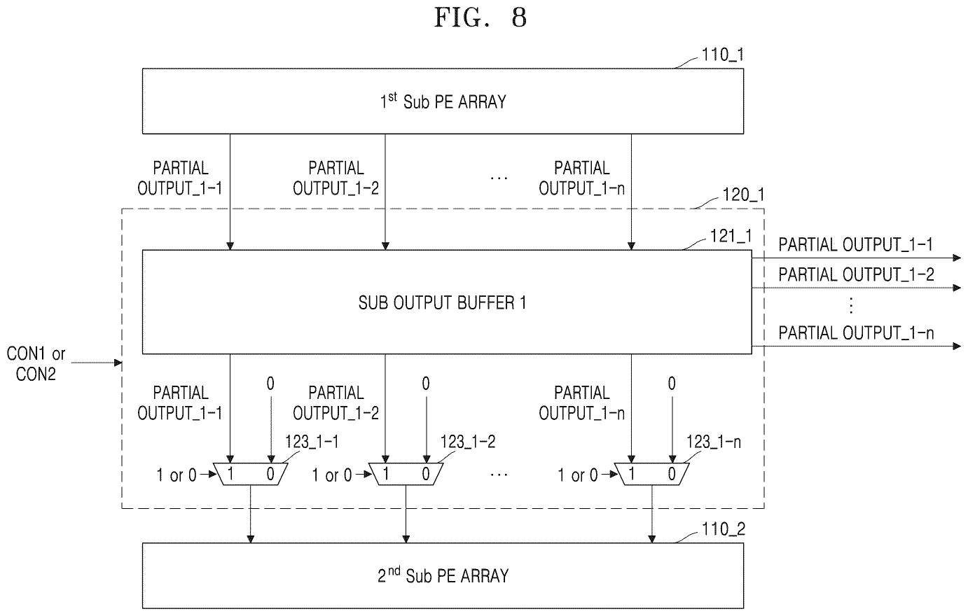

FIG. 8 illustrates the operation of one ODP circuit, according to an embodiment. FIG. 8 is a block diagram showing the configuration of the first ODP circuit 120_1 shown in FIG. 3. The plurality of ODP circuits 120 described with reference to FIG. 3 may include the same configuration and perform the same operation. Therefore, further details regarding the configuration of the first ODP circuit 120_1 shown in FIG. 3 are described herein.

The plurality of ODP circuits 120 may each include a corresponding sub output buffer and a plurality of multiplexers.

Referring to FIG. 8, the first ODP circuit 120_1 may include a first sub output buffer 121_1 and 1st-1 multiplexer 123_1-1 to 1st-n multiplexer 123_1-n.

A corresponding sub output buffer may receive an output signal of a previous sub PE array as an input. Additionally, a plurality of multiplexers may be connected to a corresponding sub output buffer.

Referring to FIG. 8, the first sub output buffer 121_1 may receive an output signal of the first sub PE array 110_1 as an input. In some cases, the output signal of the first sub PE array 110_1 may be the 1st-1 partial sum PARTIAL OUTPUT_1-1 to 1st-n partial sum PARTIAL OUTPUT_1-n. Thus, the output signal of the first sub PE array 110_1 may be the first partial sums PARTIAL OUTPUT_1.

Additionally, the corresponding sub output buffer may provide the output signal of the previous sub PE array to a plurality of multiplexers in the first mode in response to the first control signal CON1. In some cases, the plurality of multiplexers may provide the output signal of the previous sub PE array to a next sub PE array in the first mode.

Referring to FIG. 8, the first sub output buffer 121_1 may provide an output signal of the first sub PE array 110_1 to the 1st-1 to 1st-n multiplexers 123_1-1 to 123_1-n in the first mode in response to the first control signal CON1.

Additionally or alternatively, the corresponding sub output buffer may output an output signal of a previous sub PE array in the second mode in response to the second control signal CON2. For example, corresponding sub output buffers may each provide an output signal of a previous sub PE array to the restoration circuit 50 or may provide the output signal to the outside in the second mode.

Referring to FIG. 8, the first sub output buffer 121_1 may provide the output signal of the first sub PE array 110_1 in the second mode in response to the second control signal CON2. For example, the first sub output buffer 121_1 may provide the output signal of the first sub PE array 110_1 to the restoration circuit 50 or may provide the output signal of the first sub PE array 110_1 to the outside in the second mode.

Each of the plurality of multiplexers may receive a corresponding partial sum of the previous sub PE array as an input and may provide a corresponding partial sum or a 0 value to a next sub PE array in response to a control signal CON1 or CON2.

Referring to FIG. 8, a first multiplexer 123_1-1 may receive a 1st-1 partial sum PARTIAL OUTPUT_1-1 of the first sub PE array 110_1 as an input and provide a corresponding partial sum or 0 value to the second sub PE array 110_2 in response to a control signal CON1 or CON2. For example, when the first control signal CON1 indicates a bit value of 1 and the second control signal CON2 indicates a bit value of 0, the first multiplexer 123_1-1 may provide the 1st-1 partial sum PARTIAL OUTPUT_1-1 to the second sub PE array 110_2 in response to the first control signal CON1 and may provide the value of 0 to the second sub PE array 110_2 in response to the second control signal CON2.

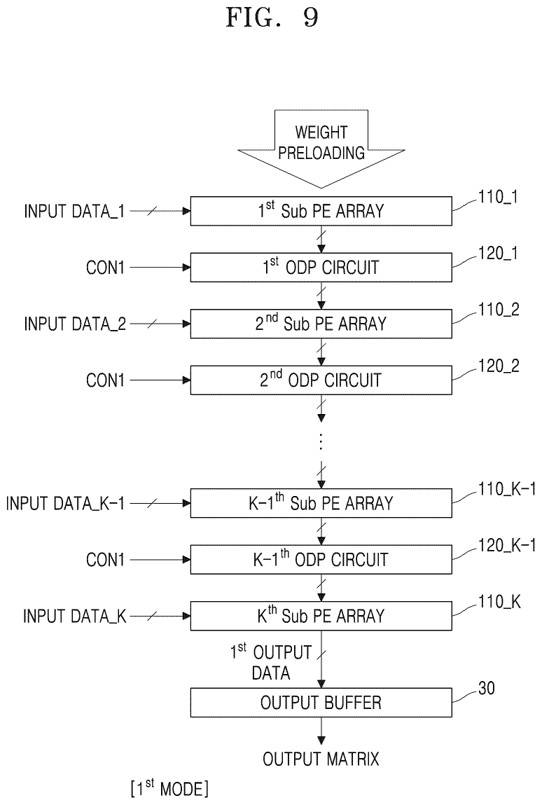

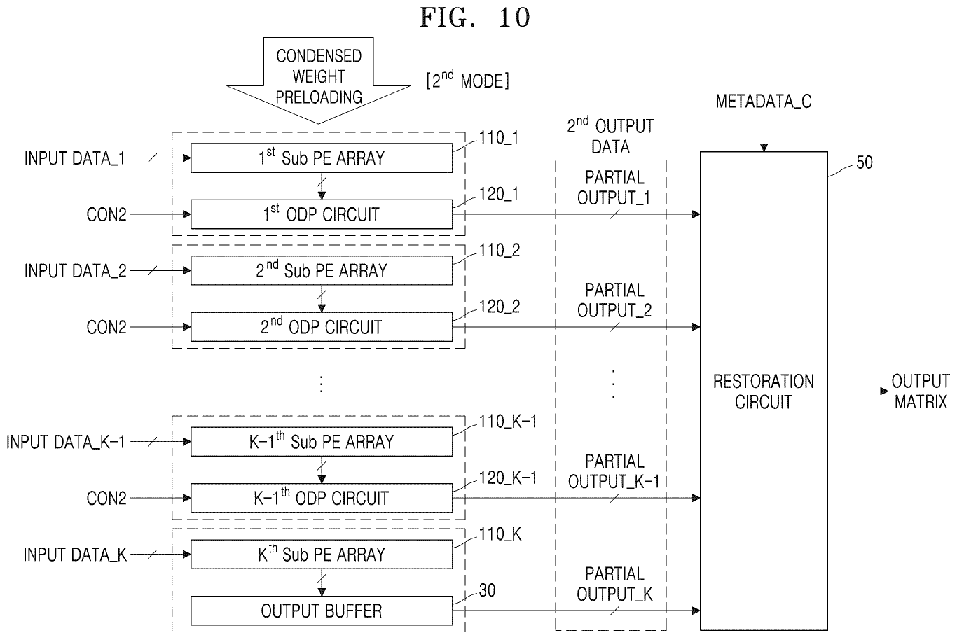

FIGS. 9 and 10 illustrate an exemplary method of operating the systolic array 100 shown in FIG. 3. FIG. 9 shows the operation of the systolic array 100 operating in the first mode and FIG. 10 shows the operation of the systolic array 100 operating in the second mode.

Referring to FIGS. 9 and 10, the systolic array 100 may include the plurality of sub PE arrays 110 and the plurality of ODP circuits 120.

Further details regarding the operation of the systolic array 100 operating in the first mode are provided with reference to FIG. 9.

Referring together to FIGS. 2 and 9, the systolic array 100 may operate in the first mode in response to the first control signal CON1 of the control circuit 60.

In some cases, the weight input circuit 20 may receive a weight matrix as an input and preload the weight data WDATA corresponding to the weight matrix to the systolic array 100 in the first mode.

In case of the first mode, each of the plurality of sub PE arrays 110 may receive corresponding input data and a result of a MAC operation of a previous sub PE array as input. In some cases, each of the plurality of sub PE arrays 110 may provide the result of the MAC operation to a corresponding ODP circuit.

For example, in the first mode, the first PE array 110_1 to K-th sub PE array 110_K may receive the first input data INPUT DATA_1 to K-th input data INPUT DATA_K and a result of a MAC operation of a previous sub PE array. As described herein, since the first sub PE array 110_1 is a starting point of a MAC operation, the first sub PE array 110_1 does not receive a result of a previous MAC operation as input. Each of the first sub PE array 110_1 to (K-1)-th sub PE array 110_K-1 may provide a result of a MAC operation to a corresponding ODP circuit, and the K-th sub PE array 110_K may provide a result of a MAC operation to the output buffer 30.

In some cases, a result of the MAC operation may refer to the partial sum, which is an accumulation of results of multiplying weight values and input values.

Additionally, corresponding input data may be any one of the 1st-1 input data INPUT DATA_1-1 to 1st-m input data INPUT DATA_1-m generated as the input circuit 10 performs a pre-processing operation on a corresponding sub column matrix of the input matrix described with reference to FIG. 5.

A result of a MAC operation received by the output buffer 30 in the first mode may refer to the first output data. In some cases, the first output data may be the final output of the systolic array 100.

Thus, the output matrix obtained by multiplying the input matrix and the weight matrix may be completed by rearranging the first output data.

The processes described in the first mode may be performed in synchronization with a clock signal.

Referring together to FIGS. 2 and 9, the systolic array 100 may operate in the second mode in response to the second control signal CON2 of the control circuit 60.

In some cases, the condensing circuit 40 may receive the weight matrix as an input and may provide the condensed weight matrix WEIGHT MATRIX_C to the weight input circuit 20 in the second mode. In some cases, the condensing circuit 40 may generate condensing metadata METADATA_C by generating a condensed matrix and may provide the condensing metadata METADATA_C to the restoration circuit 50.

Additionally, the weight input circuit 20 may receive the condensed weight matrix WEIGHT MATRIX_C as an input and may preload the weight data WDATA corresponding to the condensed weight matrix WEIGHT MATRIX_C to the systolic array 100.

Additionally, in the second mode, each of the plurality of sub PE arrays 110 may receive corresponding input data and a result of a MAC operation of a previous sub PE array as input. In some cases, each of the plurality of sub PE arrays 110 may provide the result of the MAC operation to a corresponding ODP circuit.

For example, in case of the second mode, the first sub PE array 110_1 to K-th sub PE array 110_K may receive the first input data INPUT DATA_1 to K-th input data INPUT DATA_K and a result of a MAC operation on a previous sub PE array. As described herein, since the first sub PE array 110_1 is a starting point of a MAC operation, the first sub PE array 110_1 may not receive a result of a previous MAC operation as input. Each of the first sub PE array 110_1 to (K-1)-th sub PE array 110_K-1 may provide a result of the MAC operation to a corresponding ODP circuit and the K-th sub PE array 110_K may provide a result of the MAC operation to the output buffer 30.

In the second mode, each of the plurality of ODP circuits 120 may provide a result of a MAC operation of a previous sub PE array to the restoration circuit 50. In some cases, a result of the MAC operation may refer to the partial sum which is an accumulation of results of multiplying weight values and input values.

For example, as shown in FIG. 10, in the second mode, the first ODP circuit 120_1 may provide first partial sums PARTIAL OUTPUT_1 (i.e., PARTIAL OUTPUT_1 may be a result of a MAC operation of the first sub PE array 110_1) to the restoration circuit 50. Additionally, in the second mode, the second ODP circuit 120_2 may provide second partial sums PARTIAL OUTPUT_2 (i.e., PARTIAL OUTPUT_2 may be a result of a MAC operation of the second sub PE array 110_2) to the restoration circuit 50.

In some cases, in the second mode, each of the first ODP circuit 120_1 to (K-1)-th ODP circuit 120_K-1 may provide partial sums (i.e., a partial sum may refer to a result from a MAC operation of a corresponding sub PE array) to the restoration circuit 50.

In some cases, the output buffer 30 may operate as an ODP circuit in the second mode. For example, in the second mode, the output buffer 30 may provide K-th partial sums PARTIAL OUTPUT_K (i.e., PARTIAL OUTPUT_K may be a result of a MAC operation of a K-th sub PE array 110_K) to the restoration circuit 50.

In case of the second mode, first partial sum PARTIAL OUTPUT_1 to K-th partial sum PARTIAL_K may be referred to as second output data.

The restoration circuit 50 may receive the second output data including the first partial sum PARTIAL OUTPUT_1 to K-th partial sum PARTIAL_K as an input in the second mode. The restoration circuit 50 may generate partial sum matrices based on the second output data. Additionally, the restoration circuit 50 may generate restored partial sum matrices that respectively correspond to generated partial sum matrices. In some cases, the partial sum matrices may be generated by rearranging the partial sum matrices based on the condensing metadata METADATA_C. Additionally, the restoration circuit 50 may output the output matrix based on a summation of the restored partial sum matrices. As described herein and with reference to FIG. 2, the condensing metadata METADATA_C may be provided from the condensing circuit 40.

Thus, the output matrix that is based on a product (i.e., the multiplication) of the input matrix and the weight matrix may be generated using partial sum matrices based on partial sums (e.g., the first partial sum PARTIAL OUTPUT_1 to K-th partial sum PARTIAL_K). Subsequently, restored partial sum matrices may be generated by rearranging the partial sum matrices and computing a sum of the restored partial sum matrices.

The processes described in the second mode may be performed in synchronization with a clock signal.

Additionally, one sub PE array and one ODP circuit corresponding to the sub PE array may be referred to as one sub systolic array in the second mode. In some cases, a plurality of sub systolic arrays may each independently operate as one systolic array. Thus, a plurality of sub systolic arrays may operate in parallel.

For example, a starting time point (e.g., a time period) of applying the first input data INPUT DATA_1 to the first sub PE array 110_1 and the starting time point (e.g., a time period) of applying the second input data INPUT DATA_2 to the second sub PE array 110_2 may not overlap each other in the first mode.

In some cases, the first sub PE array 110_1 and the first ODP circuit 120_1 may constitute one sub systolic array and the second sub PE array 110_2 and the second ODP circuit 120_2 may constitute one sub systolic array in the second mode. Therefore, in the second mode, a starting time point (e.g., a time period) of applying the first input data INPUT DATA_1 to the first sub PE array 110_1 and the starting time point (e.g., a time period) of applying the second input data INPUT DATA_2 to the second sub PE array 110_2 may overlap each other.

Thus, each of a plurality of sub systolic arrays may individually operate as one systolic array. As a result, the number of clock cycles needed for a MAC operation may be reduced and the processing speed of the processing circuit 1 may be improved.

FIG. 11 illustrates the operation of a condensing circuit, according to an embodiment. FIG. 11 illustrates the operation of the condensing circuit 40 shown in FIG. 2, according to an embodiment. FIG. 11 illustrates a method where the condensing circuit 40 generates the condensed weight matrix WEIGHT MATRIX_C.

FIG. 11 shows a weight matrix of 4×8 dimensions. As shown herein, white cells represent elements with a value of 0 from among elements included in the weight matrix WEIGHT MATRIX. Additionally, gray cells represent elements with values other than 0 from among the elements included in the weight matrix WEIGHT MATRIX.

In case of the second mode, the condensing circuit 40 may perform a condensing operation on the weight matrix received in response to the second control signal CON2. In some cases, the condensed weight matrix WEIGHT MATRIX_C may be generated based on the condensing operation.

In some cases, the condensing circuit 40 may divide the weight matrix into k sub row matrices each having the same number (m) of rows. Here, k may correspond to the total number of sub PE arrays. Additionally, here, m (i.e., the number of rows included in one sub row matrix) may correspond to the number of rows of PEs included in one sub PE array.

Referring to FIG. 11, the condensing circuit 40 may divide the weight matrix (e.g., original dense format weight matrix with four rows) into two sub row matrices, wherein each sub row matrix includes two rows. As shown in FIG. 11, the weight matrix may be divided into multiple groups. For example, the total number of sub PE arrays may be two and the number of rows of PEs included in one sub PE array may be two.

Thereafter, the condensing circuit 40 may delete columns where the value of each element is 0 (e.g., element value of 0 may be represented using white cells in FIG. 11). As such, the condensing circuit may maintain columns in which at least one element has a value other than 0 (e.g., columns with at least one grey cell) in each of sub column matrix. Thus, the condensed weight matrix WEIGHT MATRIX_C may be generated.

For example, referring to FIG. 11, in case of the first sub row matrix, the condensing circuit 40 may delete first, third, sixth, and seventh columns in which each element has a value of 0 and may maintain 0-th, second, fourth, and fifth columns in which at least one element has a value other than 0. Similarly, in case of the second sub row matrix, the condensing circuit may delete 0-th, first, third, fifth, and sixth columns in which each element has a value of 0 and may maintain second, fourth, and seventh columns in which at least one element has a value other than 0. As a result, the condensed weight matrix WEIGHT MATRIX_C may be generated.

Additionally, the condensing circuit 40 may generate condensing metadata METADATA_C based on generating a condensed matrix and may provide the condensing metadata METADATA_C to the restoration circuit 50.

In some cases, as the condensing circuit 40 performs a condensing operation, the condensing metadata METADATA_C may be generated to include original column indices of columns maintained in each sub row matrix.

Referring to FIG. 11, the condensing circuit 40 may generate the condensing metadata METADATA_C to include original column indices 0, 2, 4, 5 of columns maintained in the first sub row matrix and original column indices 2, 4, and 7 of columns maintained in the second sub row matrix.

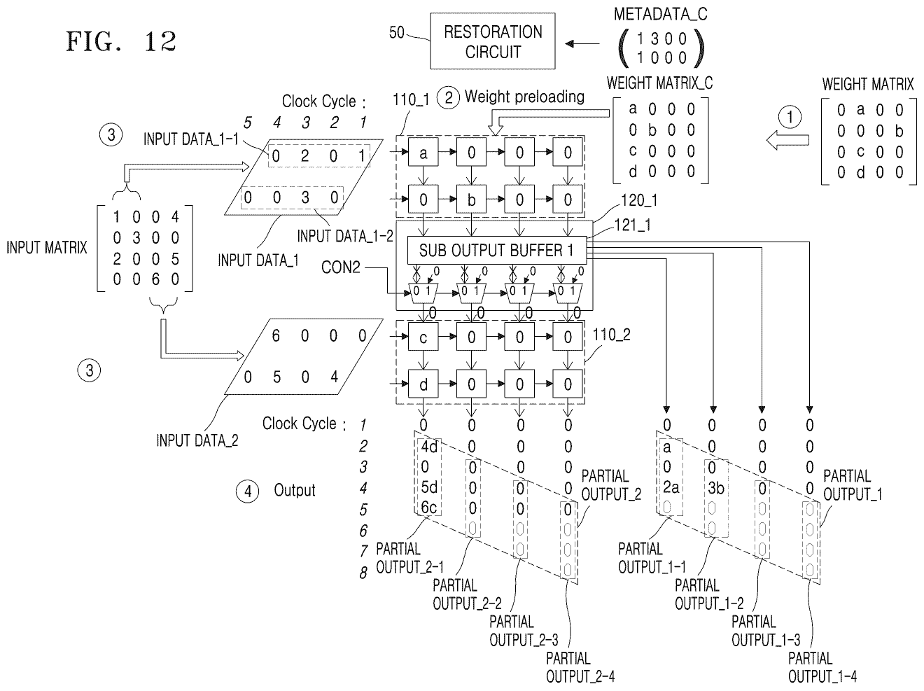

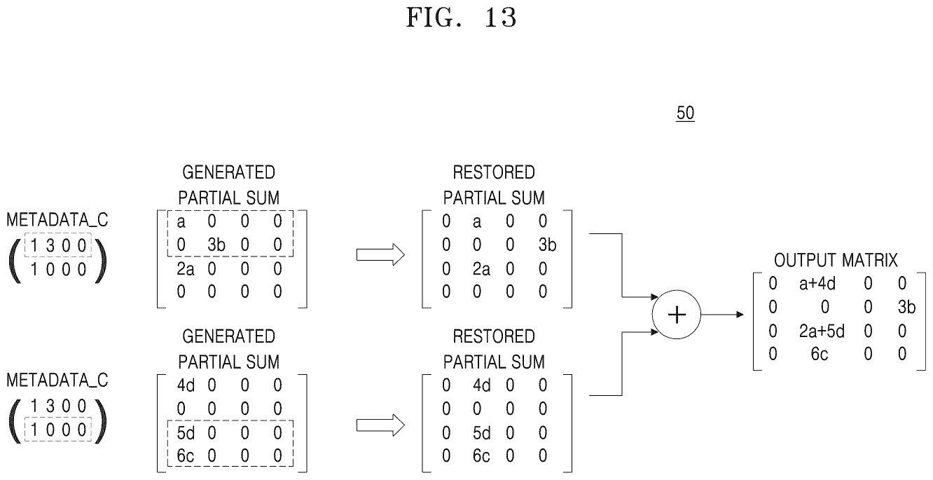

FIGS. 12 and 13 illustrate an example operation of a processing circuit, according to an embodiment. FIG. 12 illustrates an example of the systolic array 100 operating in the second mode. In some cases, the total number of sub PE arrays may be assumed as two, the number of rows of PEs included in one sub PE array may be assumed as two, and the number of ODP circuits may be assumed as one.

FIG. 12 illustrates a process comprising the systolic array 100 that performs a matrix multiplication based on performing a MAC operation on a 4×4-dimensional weight matrix WEIGHT MATRIX [0 a 0 0; 0 0 0 b; 0 c 0 0; 0 d 0 0] and a 4×4-dimensional input matrix [1 0 0 4; 0 3 0 0; 200 5; 00 6 0].

Referring together to FIGS. 2 and 12, the systolic array 100 may operate in the second mode in response to the second control signal CON2 of the control circuit 60.

In some cases, in the second mode, the condensing circuit 40 may receive the weight matrix as an input and provide the condensed weight matrix WEIGHT MATRIX_C to the weight input circuit 20. As described herein and with reference to FIG. 10, the condensing circuit 40 may generate condensing metadata METADATA_C by generating a condensed matrix and may provide the condensing metadata METADATA_C to the restoration circuit 50. Referring to FIG. 12, the condensing metadata METADATA_C may correspond to a matrix [1 3 00; 10 0 0].

Additionally, the weight input circuit 20 may receive the condensed weight matrix WEIGHT MATRIX_C as an input and may preload the weight data WDATA corresponding to the condensed weight matrix WEIGHT MATRIX_C to the systolic array 100.

Referring to FIG. 12, the condensing circuit 40 may perform a condensing operation on an input weight matrix (i.e., WEIGHT MATRIX) to generate the condensed weight matrix WEIGHT MATRIX_C [a000; 0b00; c000; d000] to the weight input circuit 20 in the second mode. Additionally, the condensing circuit 40 may generate the condensing metadata matrix METADATA_C [1 3 0 0; 1 0 0 0] and may provide the condensing metadata METADATA_C to the restoration circuit 50. As described herein and with reference to FIG. 11, the condensing metadata METADATA_C may include original indices of columns maintained in each sub row matrix as the condensing operation is performed.

Additionally, the weight input circuit 20 may receive the condensed weight matrix WEIGHT MATRIX_C [a000; 0b00; c000; d000] as an input and may preload the weight data WDATA corresponding to the condensed weight matrix WEIGHT MATRIX_C [a000; 0b00; c000; d000] to the systolic array 100.

Referring to FIG. 12, the first sub PE array 110_1 and the second sub PE array 110_2 may receive first input data INPUT DATA_1 and the second input data INPUT DATA_2, respectively, in the second mode. Additionally, the second sub PE array 110_2 may receive a result of a MAC operation of the first sub PE array 110_1 as an input. In some cases, since the first sub PE array 110_1 is a starting point of a MAC operation, the first sub PE array 110_1 may not receive a result of a previous MAC operation.

The input circuit 10 may generate input data by column-wise dividing the input matrix (e.g., based on dividing the input matrix column-by-column). Additionally, the input circuit 10 may sequentially provide the input data to the systolic array 100 in synchronization with a clock signal. As used herein, one piece of input data may correspond to one value included in each column of the input matrix and at least one piece of input data may be provided to the systolic array 100 at the same time.

Additionally, the input matrix may be divided into at least one column. For example, the input matrix may be divided into K sub column matrices, that is, first sub column matrix A1 to K-th sub column matrix AK described with reference to FIG. 4. Additionally, each sub column matrix may correspond to one of input data. For example, each of the first sub column matrix A1 to K-th sub column matrix AK in FIG. 4 may correspond to one of first input data INPUT DATA_1 to K-th input data INPUT DATA_K described in FIG. 3.

Referring again to FIG. 12, the input matrix may be divided into two sub column matrices each including two columns. The first sub column matrix A1, i.e., [1 0; 0 3; 2 0; 0 0], may correspond to the first input data INPUT DATA_1. Similarly, the second sub column matrix A2, i.e., [0 4; 0 0; 0 5; 6 0], may correspond to second input data INPUT DATA_2.

Thus, the input circuit 10 may provide the first input data INPUT DATA_1 corresponding to the first sub column matrix A1, i.e., [1 0; 0 3; 2 0; 0 0], to the first sub PE array 110_1. Additionally, the input circuit 10 may provide the second input data INPUT DATA_2 corresponding to the second sub column matrix A2, i.e., [0 4; 0 0; 0 5; 6 0], to the second sub PE array 110_2.

In some cases, the input circuit 10 may synchronize the first input data INPUT DATA_1 with a clock signal through a plurality of channels and may provide the synchronized first input data INPUT DATA_1 to the first sub PE array 110_1. As used herein, the number of channels may correspond to the number of columns of the first sub column matrix A1 and/or the number of rows of the first sub row matrix W1 described with reference to FIGS. 4 and 5. Additionally, the input circuit 10 may synchronize elements of one column of the first sub column matrix A1 with a clock signal through one channel and may sequentially provide synchronized elements to PEs of a corresponding row of the first sub PE array 110_1. Additionally, elements of the corresponding column of the corresponding sub column matrix (e.g., the first sub column matrix A1) may be sequentially moved in synchronization with a clock signal between the PEs of the corresponding row.

Referring to FIG. 12, the input circuit 10 may synchronize the 1st-1 input data INPUT DATA_1-1 and 1st-2 input data INPUT DATA_1-2 with a clock signal and may provide synchronized data to the first sub PE array 110_1. Additionally, the 1st-1 input data INPUT DATA_1-1 may sequentially move in synchronization with a clock signal between first to fourth PEs of the first row of the first sub PE array 110_1.

Thereafter, the first sub PE array 110_1 may provide a result of a MAC operation to the first ODP circuit 120_1 and the second sub PE array 110_2 may provide a result of a MAC operation to the output buffer 30 in synchronization with a clock signal.

Referring again to FIG. 12, the first sub output buffer 121_1 of the first ODP circuit 120_1 may output a matrix, i.e., [a; 0; 2a; 0], which is the 1st-1 partial sum PARTIAL OUTPUT_1-1 of the first sub PE array 110_1. Similarly, the first sub output buffer 121_1 of the first ODP circuit 120_1 may output a matrix, i.e., [0; 3b; 0; 0], which is a 1st-2 partial sum PARTIAL OUTPUT_1-2 of the first sub PE array 110_1, a matrix, i.e., [0; 0; 0; 0], which is a 1st-3 partial sum PARTIAL OUTPUT_1-3 of the first sub PE array 110_1, and a matrix, i.e., [0; 0; 0; 0], which is a 1st-4 partial sum PARTIAL OUTPUT_1-4 of the first sub PE array 110_1. Additionally, the output buffer 30 may output a matrix [4d; 0; 5d; 6c] (i.e., a 2nd-1 partial sum PARTIAL OUTPUT_2-1 of the second sub PE array 110_2), a matrix [0; 0; 0; 0] (i.e., a 2nd-2 partial sum PARTIAL OUTPUT_2-2 of the second sub PE array 110_2), a matrix [0; 0; 0; 0] (i.e., a 2nd-3 partial sum PARTIAL OUTPUT_2-3 of the second sub PE array 110_2), and a matrix [0; 0; 0; 0] (i.e., a 2nd-4 partial sum PARTIAL OUTPUT_2-4 of the second sub PE array 110_2) in synchronization with a clock signal.

As shown in FIG. 12, the first sub output buffer 121_1 and the output buffer 30 may provide the first partial sums PARTIAL OUTPUT_1 (i.e., corresponding to 1st-1 to 1st-4 partial sums PARTIAL OUTPUT_1-1 to PARTIAL OUTPUT_1-4) and the second partial sums PARTIAL OUTPUT_2 (i.e., corresponding to 2nd-1 to 2nd-4 partial sums PARTIAL OUTPUT_2-1 to PARTIAL OUTPUT_2-4) to the restoration circuit 50. In some cases, the first partial sums PARTIAL OUTPUT_1 (i.e., corresponding to the 1st-1 partial sum PARTIAL OUTPUT_1-1 to 1st-4 partial sum PARTIAL OUTPUT_1-4) and the second partial sums PARTIAL OUTPUT_2 (i.e., corresponding to the 2nd-1 partial sum PARTIAL OUTPUT_2-1 to 2nd-4 partial sum PARTIAL OUTPUT_2-4) may be referred to as second output data.

FIG. 13 illustrates a method of generating an output matrix based on the second output data. In some cases, the restoration circuit 50 may be used to generate the output matrix. Detailed descriptions are provided in continuation from FIG. 12 and repeated descriptions may be omitted.

The restoration circuit 50 may generate partial sum matrices based on the second output data. In some cases, the restoration circuit 50 may generate restored partial sum matrices respectively corresponding to generated partial sum matrices. In some cases, the restoration circuit 50 may generate restored partial sum matrices by rearranging generated partial sum matrices based on the condensing metadata METADATA_C. Additionally, the restoration circuit 50 may output the output matrix based on a summation of restored partial sum matrices. In some cases, the condensing metadata METADATA_C may be provided from the condensing circuit 40.

Referring to FIG. 13, the restoration circuit 50 may receive a matrix [a; 0; 2a; 0] (i.e., the 1st-1 partial sum PARTIAL OUTPUT_1-1 of the first sub PE array 110_1), a matrix [0; 3b; 0; 0] (i.e., the 1st-2 partial sum PARTIAL OUTPUT_1-2 of the first sub PE array 110_1), a matrix [0; 0; 0; 0] (i.e., the 1st-3 partial sum PARTIAL OUTPUT_1-3 of the first sub PE array 110_1), and a matrix [0; 0; 0; 0] (i.e., the 1st-4 partial sum PARTIAL OUTPUT_1-4 of the first sub PE array 110_1). Additionally, the restoration circuit 50 may receive the matrix [4d; 0; 5d; 6c] (i.e., the 2nd-1 partial sum PARTIAL OUTPUT_2-1 of the second sub PE array 110_2), the matrix [0; 0; 0; 0] (i.e., the 2nd-2 partial sum PARTIAL OUTPUT_2-2 of the second sub PE array 110_2), the matrix [0; 0; 0; 0] (i.e., the 2nd-3 partial sum PARTIAL OUTPUT_2-3 of the second sub PE array 110_2), and the matrix [0; 0; 0; 0] (i.e., the 2nd-4 partial sum PARTIAL OUTPUT_2-4 of the second sub PE array 110_2).

The restoration circuit 50 may generate partial sum matrices based on the second output data.

Referring to FIG. 13, the restoration circuit 50 may generate a first partial sum matrix [a 0 0 0; 0 3b 0 0; 2a 0 0 0; 00 0 0] by concatenating the matrix [a; 0; 2a; 0] (i.e., the 1st-1 partial sum PARTIAL OUTPUT_1-1 of the first sub PE array 110_1), the matrix [0; 3b; 0; 0] (i.e., the 1st-2 partial sum PARTIAL OUTPUT_1-2 of the first sub PE array 110_1), the matrix [0; 0; 0; 0] (i.e., the 1st-3 partial sum PARTIAL OUTPUT_1-3 of the first sub PE array 110_1), and the matrix [0; 0; 0; 0] (i.e., the 1st-4 partial sum PARTIAL OUTPUT_1-4 of the first sub PE array 110_1). Additionally, the restoration circuit 50 may generate a second partial sum matrix [4d 0 0 0; 0 0 0 0; 5d 0 0 0; 6c 0 0 0] by concatenating the matrix [4d; 0; 5d; 6c] (i.e., the 2nd-1 partial sum PARTIAL OUTPUT_2-1 of the second sub PE array 110_2), the matrix [0; 0; 0; 0] (i.e., the 2nd-2 partial sum PARTIAL OUTPUT_2-2 of the second sub PE array 110_2), the matrix [0; 0; 0; 0] (i.e., the 2nd-3 partial sum PARTIAL OUTPUT_2-3 of the second sub PE array 110_2), and the matrix [0; 0; 0; 0] (i.e., the 2nd-4 partial sum PARTIAL OUTPUT_2-4 of the second sub PE array 110_2).

Referring to FIG. 13, the restoration circuit 50 may generate a restored first partial sum matrix based on a first row element [1 3 0 0] of the condensed metadata METADATA_C corresponding to the matrix [1 3 0 0; 1 0 0 0]. For example, the restoration circuitry 50 may move a first row and a second row of a 0-th column of the generated first partial sum matrix to a first column according to a first column value of 1 in a first row component of the metadata METADATA_C. Additionally, the restoration circuit 50 may move a first row and a second row of a first column of the generated first partial sum matrix to a third column according to a second column value of 3 in a first row element of the metadata METADATA_C. Therefore, the restoration circuit 50 may generate the restored first partial sum matrix.

In some cases, the restoration circuit 50 may generate a restored second partial sum matrix based on a second row element [1 0 0 0] of the condensed metadata METADATA_C corresponding to the matrix [1 3 0 0; 1 0 0 0]. For example, the restoration circuit 50 may generate a restored second partial sum matrix by moving a first row and a second row of a first column of the generated second partial sum matrix to a first column according to a first column value of 1 in a second row element of the metadata METADATA_C.

Referring to FIG. 13, the restoration circuit 50 may output the output matrix based on a summation of the restored first partial sum matrix and the restored second partial sum matrix.

According to an embodiment of the present disclosure, the processing circuit 1 may operate in the first mode when the input matrix may be a dense matrix or may operate in the second mode when the input matrix may be a sparse matrix since the systolic array 100 includes the plurality of ODP circuits 120 based on the sparsity corresponding to the frequency of 0 values in an input matrix.

Therefore, according to the present disclosure, the processing circuit 1 may perform efficient matrix multiplication when the input matrix may be a dense matrix and when the input matrix may be a sparse matrix.

According to the present disclosure, operation on 0 values may be partially skipped by preloading weights corresponding to the values included in the condensed weight matrix WEIGHT MATRIX_C to the systolic array 100 in the second mode. Thus, the overall processing speed may be improved.

According to the present disclosure, a plurality of sub PE arrays may each operate as one systolic array (i.e., may operate individually) in the second mode since the systolic array 100 includes the plurality of ODP circuits 120. As a result, the number of clock cycles needed for a MAC operation may be reduced, thereby improving overall processing speed.

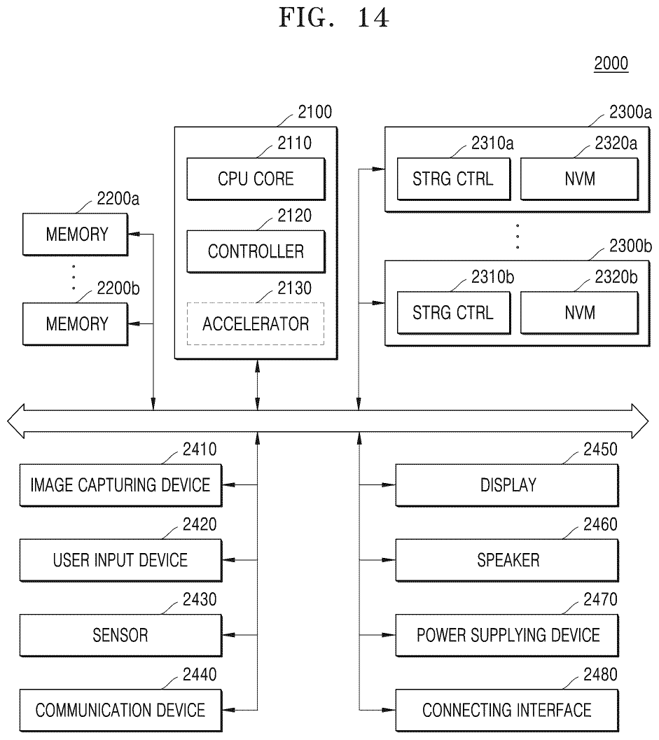

FIG. 14 shows a system to which a processing circuit may be applied according to an embodiment.

Referring to FIG. 14, a system 2000 described in FIG. 14 may basically be a mobile system such as a mobile phone, a smart phone, a tablet personal computer (PC), a wearable device, a healthcare device, or an Internet of Things (IoT) device. However, the system 2000 of FIG. 14 is not necessarily limited to a mobile system and may include a personal computer, a laptop computer, a server, a media player, or automobile device like a navigation device. The system 2000 may also be referred to as an electronic device.

Referring to FIG. 14, the system 2000 may include a main processor 2100, memory 2200a and memory 2200b, and storage devices 2300a and 2300b and may additionally include at least one of an image capturing device 2410, a user input device 2420, a sensor 2430, a communication device 2440, a display 2450, a speaker 2460, a power supplying device 2470, and a connecting interface 2480.

The main processor 2100 may control the overall operation of the system 2000, and more particularly, the operations of other components constituting the system 2000. The main processor 2100 may be implemented by a general-purpose processor, a dedicated processor, or an application processor.

The main processor 2100 may include one or more CPU cores 2110 and may further include a controller 2120 for controlling the memory 2200a and 2200b and/or the storage devices 2300a and 2300b. According to an embodiment, the main processor 2100 may further include an accelerator 2130, which may refer to a dedicated circuit for high-speed data operation such as AI data operation. The accelerator 2130 may include a graphics processing unit (GPU), a neural processing unit (NPU), and/or a data processing unit (DPU). In some cases, the accelerator 2130 may be implemented as a separate chip physically independent from the other components of the main processor 2100.

In some cases, the accelerator 2130 may correspond to the processing circuit 1 described with reference to FIGS. 1 to 13.

Memory 2200a and memory 2200b may be used as the main memory device of the system 2000 and may include volatile memories such as SRAMs and/or DRAMs. However, embodiments are not limited thereto, and the memory 2200a and 2200b may also include a non-volatile memory such as flash memories, PRAMs, and/or RRAMs. The memory 2200a and memory 2200b may be implemented in the same package as the main processor 2100.

The storage devices 2300a and 2300b may function as non-volatile storage devices that store data regardless of whether power is supplied thereto, and may have a relatively large storage capacity compared to the memory 2200a and 2200b. The storage devices 2300a and 2300b may include storage controllers 2310a and 2310b and non-volatile memory (NVMs) 2320a and 2320b that stores data under the control of the storage controllers 2310a and 2310b. The NVMs 2320a and 2320b may include a flash memory having a 2-dimensional (2D) structure or a 3-dimensional (3D) V-NAND (vertical NAND) structure, but may also include other types of non-volatile memory like a PRAM and/or an RRAM.

The storage devices 2300a and 2300b may be included in the system 2000 but physically separated from the main processor 2100 or may be implemented in the same package as the main processor 2100. Additionally, the storage devices 2300a and 2300b may be solid state devices (SSDs) or memory cards, and thus the storage devices 2300a and 2300b may be detachably attached to the other components of the system 2000 through an interface such as a connection interface 2480 to be described below. The storage devices 2300a and 2300b may be devices to which standard protocols like universal flash storage (UFS), embedded multi-media card (eMMC), or non-volatile memory express (NVMe) are applied, but are not necessarily limited thereto.

The image capturing device 2410 may capture a still image or a moving picture and may include a camera, a camcorder, and/or a webcam.

The user input device 2420 may receive various types of data input from a user of the system 2000 and may include a touch pad, a keypad, a keyboard, a mouse, and/or a microphone.

The sensor 2430 may sense various types of physical quantities that may be obtained from outside the system 2000 and may transform sensed physical quantities into electrical signals. The sensor 2430 may include a temperature sensor, a pressure sensor, an illuminance sensor, a positional sensor, an acceleration sensor, a biosensor, and/or a gyroscope sensor.

The communication device 2440 may transmit and receive signals to and from other devices outside the system 2000 according to various communication protocols. The communication device 2440 may include an antenna, a transceiver, and/or a modem.

The display 2450 and the speaker 2460 may function as output devices that output visual and auditory information to a user of the system 2000, respectively.

The power supplying device 2470 may appropriately convert power supplied from a battery (not shown) embedded to the system 2000 and/or power supplied from an external power source and may supply the converted power to the components of the system 2000.

The connection interface 2480 may provide a connection between the system 2000 and an external device, which is capable of being connected to the system 2000 and exchanging data with the system 2000. The connection interface 2480 may be implemented as one of various interface protocols such as advanced technology attachment (ATA), serial ATA (ATA), external SATA (e-SATA), small computer small interface (SCSI), aerial attached SCSI (SAS), peripheral component interconnection (PCI), PCI express (PCIe), NVM express (NVMe), IEEE 1394, universal serial bus (USB), a secure digital (SD) card, a multi-media card (MMC), an eMMC, UFS, an embedded universal flash storage (eUFS), and a compact flash (CF) card interface.

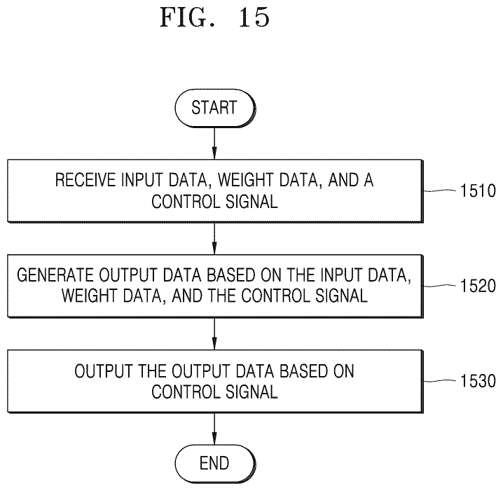

FIG. 15 shows a method of operating the systolic array, according to an embodiment of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure are configured to perform an operation on the systolic array. In some cases, the systolic array may be configured to perform a matrix multiplication operation, e.g., for performing a neural network training operation, on an input matrix to generate an output matrix. For example, the matrix multiplication operation may refer to a multiplication and accumulation (MAC) operation. According to an embodiment, the systolic array may be configured to perform a first mode or a second mode based on receiving a first control signal or a second control signal, respectively. In some examples, the control signal may be based on a density (e.g., or sparsity) of the input matrix.

According to an embodiment, a control circuit generates the first control signal in case the density of the input matrix is higher than a threshold. Additionally, according to an embodiment, the control circuit generates the second control signal in case the density of the input matrix is less than the threshold. Accordingly, by implementing different modes in the systolic array based on the control signal, embodiments of the present disclosure are able to perform a skipping of a zero weight value which results in an enhancement of the processing speed of the processing circuit. Further details regarding the implementation of the second mode are provided with reference to at least FIGS. 2-3, 7-8, and 10-11.

At operation 1510, the system receives input data, weight data, and a control signal. In some cases, the operations of this step refer to, or may be performed by, a systolic array. In some cases, the control signal may be configured to indicate a first mode or a second mode. In some cases, the weight data comprises uncondensed weight data in the first mode and condensed weight data in the second mode. Details regarding the condensing of a matrix by the condensing circuit are provided with reference to FIG. 11.

At operation 1520, the system generates output data based on the input data, weight data, and the control signal. In some cases, the operations of this step refer to, or may be performed by, the systolic array.

In some cases, the systolic array generates output data comprising partial data. For example, the systolic array generates output data based on performing a MAC operation on the input data and the weight data. For example, the weight data may refer to the uncondensed weight data in the first mode. For example, the weight data may refer to the condensed weight data in the second mode (e.g., condensed weight data generated as shown in FIG. 11). Further details regarding the output data generation are provided with reference to FIGS. 2-6.

At operation 1530, the system outputs the output data based on the control signal. In some cases, the operations of this step refer to, or may be performed by, the systolic array.

In some cases, the systolic array provides the output data to an output buffer in the first mode, where the output buffer may use the output matrix for a post-processing (e.g., normalization, activation processes in a neural network operation). Additionally or alternatively, the output buffer may reuse the output matrix as an input matrix.

In some cases, the systolic array provides the output data to a restoration circuit in the second mode. For example, the systolic array may be configured to transmit partial data to the restoration circuit. In some examples, the restoration circuit may restore the partial data (e.g., partial sum matrix generated in the sub PE array) to generate a summation matrix as the output matrix. Further details regarding the restoration circuit are provided with reference to FIGS. 2-3, 7-8, 10, and 12-13.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

While the inventive concept has been particularly shown and described with reference to embodiments thereof, it will be understood that various changes in form and details may be made therein without departing from the spirit and scope of the following claims.

1. A systolic array comprising:
a plurality of sub processing element (PE) arrays, wherein each of the plurality of sub PE arrays is configured to receive an input signal and to generate an output signal based on the received input signal; and
a plurality of output direct path (ODP) circuits configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

2. The systolic array of claim 1, wherein each ODP circuit of the plurality of ODP circuits is disposed between two consecutive sub PE arrays of the plurality of sub PE arrays.

3. The systolic array of claim 1, wherein a first time period for receiving a first input signal at a first sub PE array of the plurality of sub PE arrays overlaps a second time period for receiving a second input signal at a second sub PE array of the plurality of sub PE arrays.

4. The systolic array of claim 1, wherein the plurality of sub PE arrays is preloaded with weight values corresponding to a weight matrix in the first mode and corresponding to a condensed weight matrix in the second mode.

5. The systolic array of claim 1, wherein the ODP circuit outputs the output signal of the previous sub PE array to a restoration circuit in the second mode.

6. The systolic array of claim 1, wherein the ODP circuit comprises a sub output buffer and one or more multiplexers, wherein the sub output buffer is configured to receive the output signal of the previous sub PE array as input, and wherein the one or more multiplexers are each connected to the sub output buffer.

7. The systolic array of claim 6, wherein:
the one or more multiplexers provide the output signal of the previous sub PE array to the next sub PE array in the first mode and the sub output buffer outputs the output signal of the previous sub PE array in the second mode.

8. A processing circuit comprising a systolic array, wherein the systolic array comprises:
a plurality of sub processing element (PE) arrays, wherein each of the plurality of sub PE arrays is configured to receive an input signal and to generate an output signal based on the received input signal; and
a plurality of output direct path (ODP) circuits configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

9. The processing circuit of claim 8, wherein each ODP circuit of the plurality of ODP circuits is disposed between two consecutive sub PE arrays of the plurality of sub PE arrays.

10. The processing circuit of claim 8, wherein a first time period for receiving a first input signal at a first sub PE array of the plurality of sub PE arrays overlaps a second time period for receiving a second input signal at a second sub PE array of the plurality of sub PE arrays.

11. The processing circuit of claim 8, wherein the plurality of sub PE arrays is preloaded with weight values corresponding to a weight matrix in the first mode and corresponding to a condensed weight matrix in the second mode.

12. The processing circuit of claim 8, wherein the ODP circuit outputs the output signal of the previous sub PE array to a restoration circuit in the second mode.

13. The processing circuit of claim 8, wherein the ODP circuit comprises a sub output buffer and one or more multiplexers, wherein the sub output buffer is configured to receive the output signal of the previous sub PE array as input, and wherein the one or more multiplexers are each connected to the sub output buffer.

14. The processing circuit of claim 13, wherein:
the one or more multiplexers provide the output signal of the previous sub PE array to the next sub PE array in the first mode, and,
the sub output buffer outputs the output signal of the previous sub PE array to a restoration circuit in the second mode.

15. An electronic device comprising:
a processing circuit comprising a systolic array,
wherein the systolic array comprises:
a plurality of sub processing element (PE) arrays, wherein each of the plurality of sub PE arrays is configured to receive an input signal and to generate an output signal based on the received input signal; and
a plurality of output direct path (ODP) circuits configured to operate in a first mode and in a second mode, wherein an ODP circuit of the plurality of ODP circuits receives the output signal of a previous sub PE array of the plurality of sub PE arrays, wherein the ODP circuit provides the output signal to a next sub PE array of the plurality of sub PE arrays in the first mode, and wherein the ODP circuit outputs the output signal in the second mode.

16. The electronic device of claim 15, wherein each ODP circuit of the plurality of ODP circuits is disposed between two consecutive sub PE arrays of the plurality of sub PE arrays.

17. The electronic device of claim 15, wherein a first time period for receiving a first input signal at a first sub PE array of the plurality of sub PE arrays overlaps a second time period for receiving a second input signal at a second sub PE array of the plurality of sub PE arrays.

18. The electronic device of claim 15, wherein the plurality of sub PE arrays is preloaded with weight values corresponding to a weight matrix in the first mode and corresponding to a condensed weight matrix in the second mode.

19. The electronic device of claim 15, wherein the ODP circuit outputs the output signal of the previous sub PE array to a restoration circuit in the second mode.

20. The electronic device of claim 15, wherein the ODP circuit comprises a sub output buffer and one or more multiplexers, wherein the sub output buffer is configured to receives the output signal of the previous sub PE array as input, and wherein the one or more multiplexers are each connected to the sub output buffer.

21-23. (canceled)
